(19) United States
(12) Patent Application Publication
(10) Pub. No.: US 2022/0297720 A1
(43) Pub. Date: Sep. 22, 2022

(54) APPARATUS, METHOD, AND COMPUTER PROGRAM FOR ASSIGNING PRIORITIES TO TRAFFIC LANES

(71) Applicant: TOYOTA JIDOSHA KABUSHIKI KAISHA, Toyota-shi (JP)

(72) Inventors: Ichi GI, Nagoya-shi (JP); Shuichi MORIMOTO, Edogawa-ku (JP); Shun FUJIOKA, Sumida-ku (JP)

(21) Appl. No.: 17/655,234

(22) Filed: Mar. 17, 2022

(30) Foreign Application Priority Data
Mar. 17, 2021 (JP) 2021-043614

(51) Int. Cl. B60W 60/00; G06V 20/56

(52) U.S. Cl. CPC B60W 60/001; G06V 20/588; B60W 2552/53

(57) ABSTRACT

An apparatus for assigning priorities to traffic lanes detects a plurality of lanes reachable by a vehicle from a travel lane of the vehicle without straddling a lane line, and assigns a higher priority to at least one of the plurality of lanes than to the plurality of lanes except the at least one lane in the case that the plurality of lanes is included in the same road, that the at least one of the plurality of lanes adjoins a lane included in the road other than the plurality of lanes with a lane line in between, and that the plurality of lanes except the at least one lane does not adjoin any lane included in the road other than the plurality of lanes with a lane line in between.

### FIELD

The present disclosure relates to an apparatus, a method, and a computer program for assigning priorities to traffic lanes traveled by vehicles.

### BACKGROUND

A known vehicle can autonomously travel on a current travel lane, based on map data and circumstances.

Japanese Unexamined Patent Publication No. 2019-202690 (hereafter, “Patent Literature 1”) describes a travel controller that controls travel of a vehicle. When travelable travel lanes are recognized in a travel direction of a host vehicle, the travel controller described in Patent Literature 1 selects a lane to be traveled by the host vehicle out of the travel lanes, based on a set vehicle speed.

### SUMMARY

The travel controller described in Patent Literature 1 selects a travel lane, depending on whether the set vehicle speed based on circumstances and designation by an occupant is less than a threshold, and generates a trajectory.

When a lane is selected on the basis of the set vehicle speed, the circumstances are not taken into account. For this reason, the selected lane may differ from the lane expected by the driver, depending on the circumstances. A travel controller that selects a lane in this way may make a driver disagreeable, and is not preferable.

It is an object of the present disclosure to provide an apparatus that can assign priorities to traffic lanes without making a driver disagreeable.

An apparatus for assigning priorities to traffic lanes according to the present disclosure includes a processor configured to detect a plurality of lanes reachable by a vehicle from a travel lane of the vehicle without straddling a lane line; and assign a higher priority to at least one of the plurality of lanes than to the plurality of lanes except the at least one lane in the case that the plurality of lanes is included in the same road, that the at least one of the plurality of lanes adjoins a lane included in the road other than the plurality of lanes with a lane line in between, and that the plurality of lanes except the at least one lane does not adjoin any lane included in the road other than the plurality of lanes with a lane line in between.

The processor of the apparatus according to the present disclosure in the assigning preferably assigns priorities to the plurality of lanes so that a lane closer to the at least one lane has a higher priority.

The processor of the apparatus according to the present disclosure in the assigning preferably assigns a higher priority to one of the plurality of lanes to be reached from the travel lane of the vehicle through a trajectory with a smaller bend.

The processor of the apparatus according to the present disclosure is preferably further configured to control the vehicle so as to travel on one of the plurality of lanes assigned the highest priority.

A method for assigning priorities to traffic lanes according to the present disclosure includes detecting a plurality of lanes reachable by a vehicle from a travel lane of the vehicle without straddling a lane line; and assigning a higher priority to at least one of the plurality of lanes than to the plurality of lanes except the at least one lane in the case that the plurality of lanes is included in the same road, that the at least one of the plurality of lanes adjoins a lane included in the road other than the plurality of lanes with a lane line in between, and that the plurality of lanes except the at least one lane does not adjoin any lane included in the road other than the plurality of lanes with a lane line in between.

A computer program for assigning priorities to traffic lanes according to the present disclosure recorded on a non-transitory computer readable medium causes a processor mounted on a vehicle to execute a process including: detecting a plurality of lanes reachable by the vehicle from a travel lane of the vehicle without straddling a lane line; and assigning a higher priority to at least one of the plurality of lanes than to the plurality of lanes except the at least one lane in the case that the plurality of lanes is included in the same road, that the at least one of the plurality of lanes adjoins a lane included in the road other than the plurality of lanes with a lane line in between, and that the plurality of lanes except the at least one lane does not adjoin any lane included in the road other than the plurality of lanes with a lane line in between.

The apparatus according to the present disclosure can assign priorities to traffic lanes without making a driver disagreeable.

### BRIEF DESCRIPTION OF DRAWINGS

FIG. 1 schematically illustrates the configuration of a vehicle equipped with an apparatus for assigning priorities to traffic lanes.

FIG. 2 schematically illustrates the hardware of an ECU.

FIG. 3 is a functional block diagram of a processor included in the ECU.

FIG. 4 is a diagram for explaining a first example of lane priority assignment.

FIG. 5 is a diagram for explaining a second example of lane priority assignment.

FIG. 6 is a flowchart of a lane priority assigning process.

### DESCRIPTION OF EMBODIMENTS

Hereinafter, an apparatus that can assign priorities to traffic lanes without making a driver disagreeable will be explained in detail with reference to the drawings. The apparatus detects a plurality of lanes reachable by a vehicle from a travel lane of the vehicle without straddling a lane line. The apparatus then assigns a higher priority to at least one of the plurality of lanes than to the plurality of lanes except the at least one lane in the case that the plurality of lanes is included in the same road, that the at least one of the plurality of lanes adjoins a lane included in the road other than the plurality of lanes with a lane line in between, and that the plurality of lanes except the at least one lane does not adjoin any lane included in the road other than the plurality of lanes with a lane line in between.

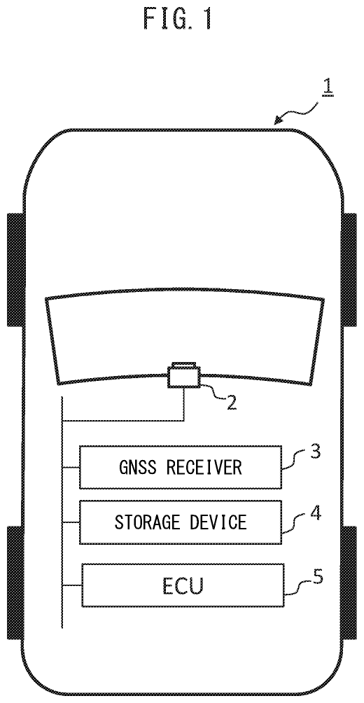

FIG. 1 schematically illustrates the configuration of a vehicle equipped with the apparatus for assigning priorities to traffic lanes.

The vehicle 1 includes a camera 2, a global navigation satellite system (GNSS) receiver 3, a storage device 4, and an electronic control unit (ECU) 5. The camera 2, the GNSS receiver 3, and the storage device 4 are connected to the ECU 5 via an in-vehicle network conforming to a standard, such as a controller area network, so that they can communicate with each other.

The camera 2 is an example of a sensor for detecting the surroundings of the vehicle. The camera 2 includes a two-dimensional detector constructed from an array of optoelectronic transducers, such as CCD or C-MOS, having sensitivity to visible light and a focusing optical system that forms an image of a target region on the two-dimensional detector. The camera 2 is disposed, for example, in a front and upper area in the interior of the vehicle and oriented forward, takes a picture of the surroundings of the vehicle 1 through a windshield every predetermined capturing period (e.g., 1/30 to 1/10 seconds), and outputs images corresponding to the surroundings.

The GNSS receiver 3 receives GNSS signals from GNSS satellites at predetermined intervals, and determines the position of the vehicle 1, based on the received GNSS signals. The GNSS receiver 3 outputs a positioning signal indicating the result of determination of the position of the vehicle 1 based on the GNSS signals to the ECU 5 via the in-vehicle network at predetermined intervals.

The storage device 4 is an example of a storage unit, and includes, for example, a hard disk drive or a nonvolatile semiconductor memory. The storage device 4 contains a high-precision map, which includes, for example, information indicating lane lines on roads included in a predetermined region shown on this map.

The ECU 5 includes a communication interface, a memory, and a processor. The ECU 5, which is an example of the apparatus for assigning priorities to traffic lanes, detects lanes ahead of the vehicle 1, based on an image received from the camera 2 via the communication interface, and assigns priorities to the lanes.

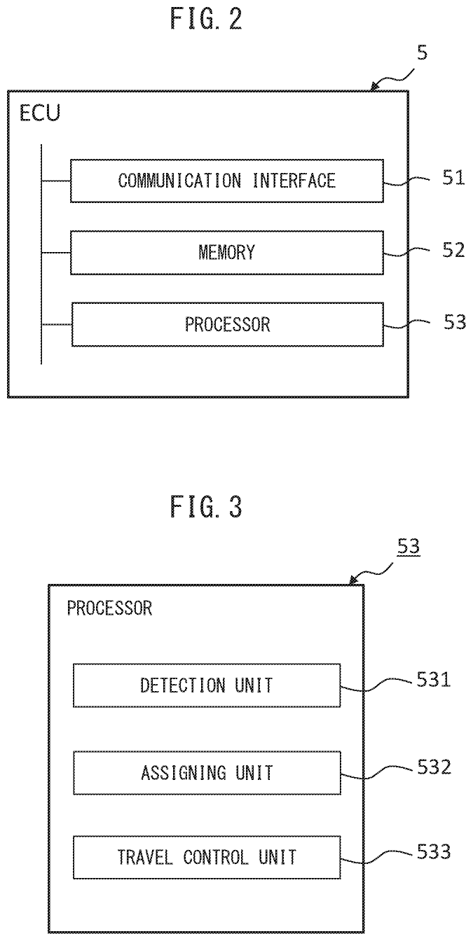

FIG. 2 schematically illustrates the hardware of the ECU 5. The ECU 5 includes a communication interface 51, a memory 52, and a processor 53.

The communication interface 51 is an example of a communication unit, and includes a communication interface circuit for connecting the ECU 5 to the in-vehicle network. The communication interface 51 provides received data for the processor 53, and outputs data provided from the processor 53 to an external device.

The memory 52 is an example of a storage unit, and includes volatile and nonvolatile semiconductor memories. The memory 52 contains various types of data used for processing by the processor 53, such as parameters for setting a neural network for detecting lane lines from an image generated by the camera 2. The memory 52 also contains various application programs, such as a lane priority assigning program for executing a lane priority assigning process.

The processor 53 is an example of a control unit, and includes one or more processors and a peripheral circuit thereof. The processor 53 may further include another operating circuit, such as a logic-arithmetic unit, an arithmetic unit, or a graphics processing unit.

FIG. 3 is a functional block diagram of the processor 53 included in the ECU 5.

As its functional blocks, the processor 53 of the ECU 5 includes a detection unit 531, an assigning unit 532, and a travel control unit 533. These units included in the processor 53 are functional modules implemented by a computer program executed on the processor 53, or may be implemented in the ECU 5 as separate integrated circuits, microprocessors, or firmware.

The detection unit 531 inputs an image received from the camera 2 via the communication interface into a classifier that has been trained to detect lane lines, thereby detecting lane lines ahead of the vehicle 1. Lane lines are demarcation lines drawn for dividing lanes on a road.

The classifier may be, for example, a convolutional neural network (CNN) including convolution layers connected in series from the input toward the output. A CNN that has been trained using inputted images including lane lines as training data operates as a classifier to detect lane lines.

The detection unit 531 detects a plurality of lanes reachable by the vehicle 1 from the travel lane of the vehicle 1 without straddling a lane line, based on lane lines detected from a received image. For example, assume that three lane lines are detected ahead of the vehicle 1, and that trajectories leading from the current position of the vehicle 1 to the two respective lanes ahead of the vehicle 1 defined by the three lane lines can be generated without straddling a lane line. In this case, the detection unit 531 detects the two lanes ahead of the vehicle 1 as lanes reachable by the vehicle 1 from the travel lane of the vehicle 1 without straddling a lane line.

The detection unit 531 may detect a plurality of lanes reachable by the vehicle 1 from the travel lane of the vehicle 1 without straddling a lane line, based on a high-precision map stored in the storage device 4. For example, the detection unit 531 receives a positioning signal from the GNSS receiver 3, and obtains a high-precision map of the location corresponding to the positioning signal from the storage device 4. The detection unit 531 then detects a plurality of lanes reachable by the vehicle 1 from the travel lane of the vehicle 1 without straddling a lane line, based on information on lane lines in the high-precision map.

The assigning unit 532 determines whether the detected plurality of lanes reachable by the vehicle 1 from the travel lane of the vehicle 1 without straddling a lane line is included in the same road. In the present disclosure, a plurality of lanes being “included in the same road” means that each of the lanes corresponds to one of the lanes defined by dividing one road. For example, when one of lanes is included in a road that splits from the road including the current travel lane and that leads to a different location, the one of the lanes and the other lane(s) are not included in the same road.

When the plurality of lanes is included in the same road, the assigning unit 532 determines whether each of the plurality of lanes adjoins a lane included in the road other than the plurality of lanes with a lane line in between.

The assigning unit 532 then assigns a higher priority to at least one of the plurality of lanes adjoining a lane included in the road other than the plurality of lanes with a lane line in between than to the plurality of lanes except the at least one lane, and stores the priority in the memory 52.

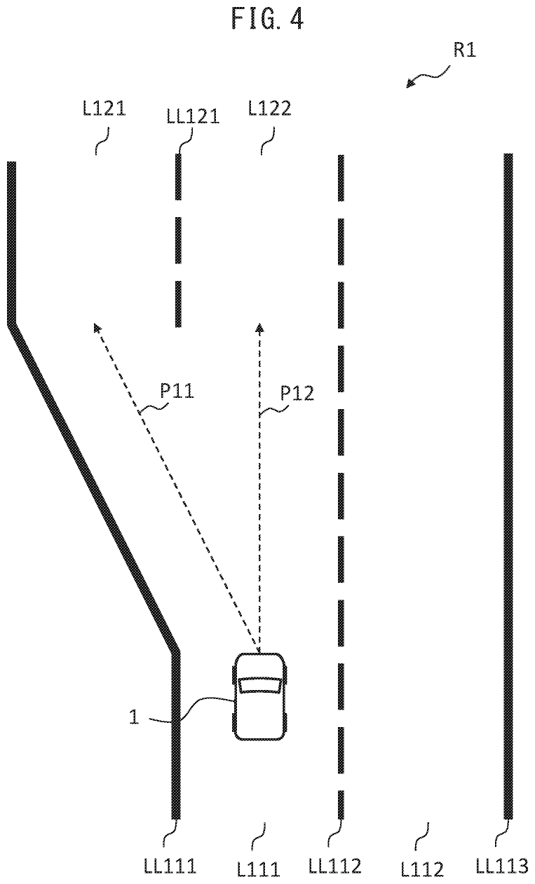

FIG. 4 is a diagram for explaining a first example of lane priority assignment.

FIG. 4 represents a road R1 including a lane L111 defined by lane lines LL111 and LL112 and a lane L112 defined by lane lines LL112 and LL113 as well as the vehicle 1 traveling on the lane L111.

The detection unit 531 detects a lane L121 defined by lane lines LL111 and LL121 and a lane L122 defined by the lane lines LL121 and LL112 ahead of the vehicle 1.

A trajectory P11 leading from the current position of the vehicle 1 to the lane L121 and a trajectory P12 leading from the current position of the vehicle 1 to the lane L122 do not straddle a lane line. Thus, the detection unit 531 detects the lanes L121 and L122 as a plurality of lanes reachable by the vehicle 1 from the travel lane of the vehicle 1 without straddling a lane line.

In the example of FIG. 4, the plurality of lanes L121 and L122 is included in the same road R1. The lane L112 corresponds to a lane included in the road R1 other than the plurality of lanes. Thus, the assigning unit 532 assigns a higher priority to the lane L122 adjoining the lane L112 than to the lane L121 that does not adjoin the lane L112.

The assigning unit 532 may assign priorities to the plurality of lanes so that a lane closer to the at least one lane has a higher priority. For example, assume that three lanes reachable by the vehicle from the travel lane of the vehicle without straddling a lane line are detected, and that the rightmost one of the three lanes adjoins a fourth lane on the right with a lane line in between. In this case, the assigning unit 532 assigns the highest priority to the rightmost lane closest to the fourth lane of the three lanes, the lowest priority to the leftmost lane farthest from the fourth lane, and the medium priority, which ranks between the priorities of the rightmost and leftmost lanes, to the center lane.

Additionally, the assigning unit 532 assigns a higher priority to one of the plurality of lanes to be reached from the travel lane of the vehicle through a trajectory with a smaller bend.

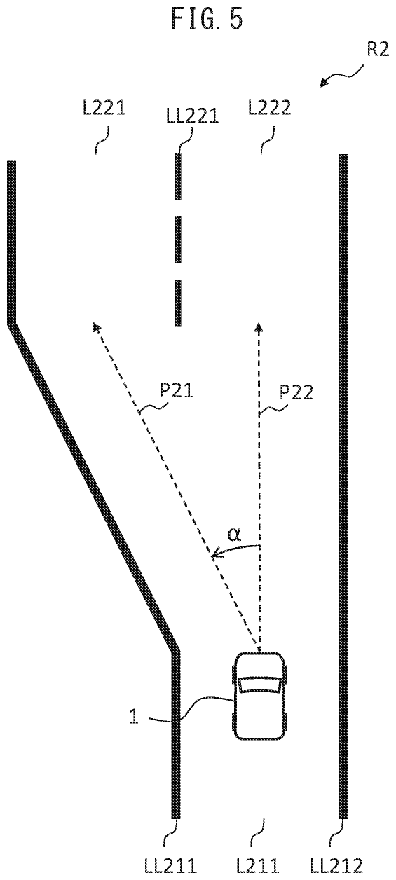

FIG. 5 is a diagram for explaining a second example of lane priority assignment.

FIG. 5 represents a road R2 including a lane L211 defined by lane lines LL211 and LL212 as well as the vehicle 1 traveling on the lane L211.

The detection unit 531 detects a lane L221 defined by lane lines LL211 and LL221 and a lane L222 defined by the lane lines LL221 and LL212 ahead of the vehicle 1.

A trajectory P21 leading from the current position of the vehicle 1 to the lane L221 and a trajectory P22 leading from the current position of the vehicle 1 to the lane L222 do not straddle a lane line. Thus, the detection unit 531 detects the lanes L221 and L222 as a plurality of lanes reachable by the vehicle 1 from the travel lane of the vehicle 1 without straddling a lane line.

In the example of FIG. 5, the plurality of lanes L221 and L222 is included in the same road R2. The road R2 does not include any lane other than the plurality of lanes. The trajectory P21 to the lane L221 bends at an angle a whereas the trajectory P22 to the lane L222 does not bend. Thus, the assigning unit 532 assigns a higher priority to the lane L222, which will be reached through the trajectory with a smaller bend, than to the lane L221, which will be reached through the trajectory with a larger bend.

The travel control unit 533 outputs control signals to a travel mechanism (not shown) of the vehicle 1 via the communication interface 51 so as to travel on one of the plurality of lanes assigned the highest priority. The travel mechanism includes, for example, an engine or a motor for supplying motive power to the vehicle 1, brakes for decreasing the travel speed of the vehicle 1, and a steering mechanism for steering the vehicle 1.

The travel control unit 533 may identify one or more of the plurality of lanes included in a route from the current position to a destination, and output control signals to the travel mechanism so as to travel on one of the identified lanes assigned the highest priority.

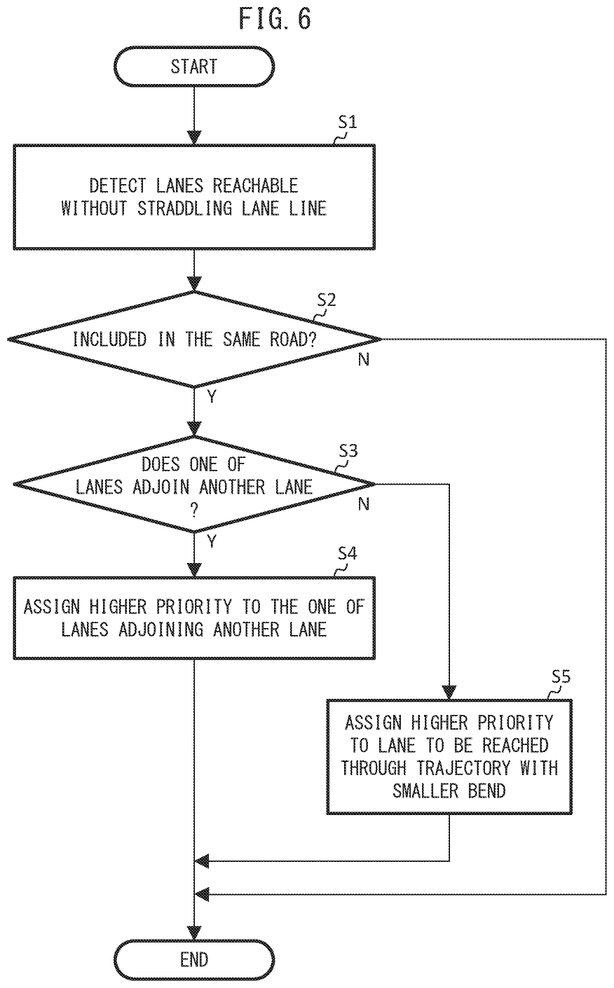

FIG. 6 is a flowchart of a lane priority assigning process. The ECU 5 repeats this process at predetermined intervals (e.g., intervals of 1/10 seconds) during travel of the vehicle 1.

First, the detection unit 531 of the ECU 5 detects a plurality of lanes reachable by the vehicle 1 from the travel lane of the vehicle 1 without straddling a lane line (step S1).

Next, the assigning unit 532 of the ECU 5 determines whether the plurality of lanes is included in the same road (step S2). When it is determined that the plurality of lanes is not included in the same road (No in Step S2), it terminates the lane priority assigning process.

When it is determined that the plurality of lanes is included in the same road (Yes in Step S2), the assigning unit 532 determines whether at least one of the plurality of lanes adjoins a lane included in the road other than the plurality of lanes with a lane line in between (step S3).

When it is determined that at least one of the plurality of lanes adjoins a lane included in the road other than the plurality of lanes with a lane line in between (Yes in Step S3), the assigning unit 532 assigns a higher priority to the at least one of the plurality of lanes than to the plurality of lanes except the at least one lane (step S4) and terminates the lane priority assigning process.

When it is determined that none of the plurality of lanes adjoins any lane included in the road other than the plurality of lanes with a lane line in between (No in Step S3), the assigning unit 532 assigns a higher priority to one of the plurality of lanes to be reached from the travel lane of the vehicle through a trajectory with a smaller bend (step S5) and terminates the lane priority assigning process.

This lane priority assigning process enables the ECU 5 to assign priorities to traffic lanes without making a driver disagreeable.

A computer program for achieving the functions of the units of the processor 53 of the ECU 5 may be provided in a form recorded on a computer-readable and portable medium, such as a semiconductor memory, a magnetic recording medium, or an optical recording medium.

Note that those skilled in the art can apply various changes, substitutions, and modifications without departing from the spirit and scope of the present disclosure.

What is claimed is:

1. An apparatus for assigning priorities to traffic lanes, comprising a processor configured to
detect a plurality of lanes reachable by a vehicle from a travel lane of the vehicle without straddling a lane line; and
assign a higher priority to at least one of the plurality of lanes than to the plurality of lanes except the at least one lane in the case that the plurality of lanes is included in the same road, that the at least one of the plurality of lanes adjoins a lane included in the road other than the plurality of lanes with a lane line in between, and that the plurality of lanes except the at least one lane does not adjoin any lane included in the road other than the plurality of lanes with a lane line in between.

2. The apparatus according to claim 1, wherein the processor in the assigning assigns priorities to the plurality of lanes so that a lane closer to the at least one lane has a higher priority.

3. The apparatus according to claim 1, wherein the processor in the assigning assigns a higher priority to one of the plurality of lanes to be reached from the travel lane of the vehicle through a trajectory with a smaller bend.

4. The apparatus according to claim 1, wherein the processor is further configured to control the vehicle so as to travel on one of the plurality of lanes assigned the highest priority.

5. A method for assigning priorities to traffic lanes, comprising:
detecting a plurality of lanes reachable by a vehicle from a travel lane of the vehicle without straddling a lane line; and
assigning a higher priority to at least one of the plurality of lanes than to the plurality of lanes except the at least one lane in the case that the plurality of lanes is included in the same road, that the at least one of the plurality of lanes adjoins a lane included in the road other than the plurality of lanes with a lane line in between, and that the plurality of lanes except the at least one lane does not adjoin any lane included in the road other than the plurality of lanes with a lane line in between.

6. A non-transitory recording medium having recorded thereon a computer program for assigning priorities to traffic lanes, the computer program causing a processor mounted on a vehicle to execute a process comprising:
detecting a plurality of lanes reachable by the vehicle from a travel lane of the vehicle without straddling a lane line; and
assigning a higher priority to at least one of the plurality of lanes than to the plurality of lanes except the at least one lane in the case that the plurality of lanes is included in the same road, that the at least one of the plurality of lanes adjoins a lane included in the road other than the plurality of lanes with a lane line in between, and that the plurality of lanes except the at least one lane does not adjoin any lane included in the road other than the plurality of lanes with a lane line in between.
